(19) United States
(12) Patent Application Publication
(10) Pub. No.: US 2014/0149159 A1
(43) Pub. Date: May 29, 2014

(54) Process for grading, on a standardized scale, the technical condition of an asset

(71) Applicants: Anthony Kioussis, Viewtown, VA (US); Francisco Picornell, Indialantic, FL (US)

(72) Inventors: Anthony Kioussis, Viewtown, VA (US); Francisco Picornell, Indialantic, FL (US)

(21) Appl. No.: 13/998,548

(22) Filed: Nov. 8, 2013

Related U.S. Application Data
(60) Provisional application No. 61/796,417, filed on Nov. 10, 2012.

(51) Int. Cl. G06Q 10/06

(52) U.S. Cl. CPC G06Q 10/063
USPC 705/7.11

(57) ABSTRACT

This invention relates generally to the field of Asset Management and more specifically to a process for grading, on a standardized scale, the technical condition of an Asset that has a Scheduled Maintenance Program issued by the Asset's manufacturer or other governing authority, and is comprised of the following: an Asset Technical Condition Score that evaluates and measures an Asset's technical condition, relative to its Optimal Technical Condition, with respect to the Asset's Scheduled Maintenance Program; an Asset Technical Financial Exposure Value, representing and measuring an Asset's accrued Inspection liability due to utilization or other technical aging influence, based on its Optimal Inspection Liability, with respect to the Asset's Scheduled Maintenance Program; and, an Asset Technical Financial Condition Score representing and measuring an Asset's financial rating, relative to its Optimal Technical Condition, with respect to the Asset's Scheduled Maintenance Program.

### CROSS REFERENCE TO RELATED APPLICATIONS

This application claims priority to U.S. Provisional Patent Application No. 61/796,417 entitled “A process for for establishing an Asset Grading System” filed Nov. 10, 2012 which is incorporated herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### THE NAMES OF THE PARTIES TO A JOINT RESEARCH AGREEMENT

Not Applicable

### BACKGROUND OF THE INVENTION

This invention relates generally to the field of Asset Management (any system that monitors and maintains Assets. A systematic process of operating, maintaining, upgrading, and disposing of Assets cost-effectively) and more specifically to a process for grading, on a standardized scale, the technical condition of an Asset that has a Scheduled Maintenance Program issued by the Asset's manufacturer or other governing authority—an Asset Grading System Process (a process for grading, on a standardized scale, the technical condition of Assets).

The Asset Grading System Process derives the Asset Technical Index (an Asset's grade, as derived by the Asset Grading System Process, comprised of the Asset Technical Condition Score, the Asset Technical Financial Condition Score, and the Asset Technical Financial Exposure Value) that is comprised of the following:
An Asset Technical Condition Score (the “ATC Score”) that evaluates and measures an Asset's technical condition, relative to its Optimal Technical Condition (a technical condition for an Asset that cannot be improved upon), with respect to multiple maintenance variables including the Asset's Scheduled Maintenance Program.
An Asset Technical Financial Exposure Value (the “ATFE Value”), representing and measuring the Asset's accrued Inspection (a specific maintenance event specified by the Scheduled Maintenance Program) liability due to utilization or any other technical aging influence, based on its Optimal Inspection Liability (an Asset that has accrued no Inspection Costs based on its Scheduled Maintenance Program), with respect to multiple maintenance variables including the Asset's Scheduled Maintenance Program.
An Asset Technical Financial Condition Score (the “ATFC Score”) representing and measuring an Asset's financial rating, relative to its Optimal Technical Condition, with respect to multiple maintenance variables including the Asset's Scheduled Maintenance Program.

By deriving the Asset Technical Index, the AGS Process (a process for grading, on a standardized scale, the technical condition of Assets):
Provides a uniform methodology, utilizing a standardized scale, for comparing the ATC Score, ATFE Value, and/or ATC Score of an Asset in relation to other, similar, dissimilar, and/or unique class/type Assets.
Processes technical data and generates an easily understood Index (an Asset's grade, as derived by the Asset Grading System Process, comprised of the Asset Technical Condition Score, the Asset Technical Financial Condition Score, and the Asset Technical Financial Exposure Value) for an Asset.
Defines consistent technical parameters for evaluating the technical condition of similar, dissimilar, and/or unique class/type Assets.
Provides the ability to generate an Asset Technical Index for the entire Asset and, to the extent appropriate for that class/type Asset, an Asset Technical Index for the Asset's components and subcomponents, thus providing a uniform, simple to understand, yet detailed evaluation of an Asset, its components, and subcomponents, or any other logically derived technical makeup of an Asset.
Clearly defines the role the Asset's technical condition plays in producing a set of data that can be translated into a standardized numeric, alphabetic, alphanumeric, or any other grading scale that can be acted upon to protect and/or enhance the Asset's technical rating.

Historically, analysis of an Asset's technical condition has been vague, if not misunderstood, and difficult to place into comparative context. No uniform methodology has been available to allow an Asset to be graded relative to its Optimal Technical Condition and then directly compared to another Asset, as well as what Financial Exposure (the Asset Technical Financial Exposure Value (“ATFE Value”) of an Asset) each Asset's technical condition posed to the overall value of the Asset at the time the analysis was conducted. Additionally:
An Asset's technical condition information has often been presented in complex technical language, and with too many variables, all strung together yet still unable to present an understandable overview of the Asset.
Interpretation of the technical data has been inconsistent because no two individuals will describe the technical condition of an Asset the same way. This has made it difficult to attain a consistent understanding of an Asset's technical status history and current condition. Additionally, this issue has made it difficult to compare similar Assets.
Asset technical condition analyses have been primarily focused on an Asset's operational and compliance status. Because technical data has historically been collected and analyzed on that basis, it has been difficult for parties of non-technical disciplines to understand an Asset's technical condition and what Financial Exposure the Asset's technical condition poses to the overall value of the Asset. The AGS Process allows non-technical disciplines to use technical condition information in a more meaningful manner.

### BRIEF SUMMARY OF THE INVENTION

The primary objective of the invention is to provide a uniform process for grading the technical condition of an Asset, including its related components, subcomponents, or any other logically derived technical makeup, and the Asset's related Financial Exposure.

Additional objectives of this invention are to:
Provide a systematic, standardized approach for grading the technical condition and Financial Exposure of a single asset or a portfolio of similar, dissimilar, and/or unique type assets.
Process technical data and generate an easy to understand grading Index for use in rating an Asset's technical condition and its Financial Exposure.
Provide the ability to generate a grade for the entire Asset and, to the extent appropriate for that class/type of Asset, the Asset Technical Index for the Asset's related components and subcomponents, and/or any other logically derived technical makeup.
Clearly define the role that the Asset's technical condition plays, as part of a larger set of variables, to produce a set of data that can be translated into financial terms able to be acted upon to protect and/or enhance an Asset's financial performance.
Provide a systematically applied process to identify technical condition value enhancement or degradation trends with respect to a single and/or portfolio/group of Assets. In addition to the traditional focus on operational compliance, the invention introduces a strategic and value performance focus to the same core data.
Provide a simple to understand approach for evaluating an Asset in relation to its Optimal Technical Condition in such a way that the overall financial performance of the Asset can be derived and measurably improved.

Other objectives and advantages of the present invention will become apparent from the following descriptions, and the accompanying drawings, wherein, by way of illustrations and examples, an embodiment of the present invention is disclosed.

In accordance with a preferred embodiment of the invention, there is disclosed a process for an Asset Grading System that derives an Asset Technical Index comprised of the following:
An Asset Technical Condition Score (the “ATC Score”) that evaluates and measures an Asset's technical condition, relative to its Optimal Technical Condition, with respect to multiple maintenance variables including the Asset's Scheduled Maintenance Program.
An Asset Technical Financial Exposure Value (the “ATFE Value”), representing and measuring the Asset's accrued Inspection liability due to utilization or other technical aging influence, based on its Optimal Inspection Liability, with respect to multiple maintenance variables including the Asset's Scheduled Maintenance Program.
An Asset Technical Financial Condition Score (the “ATFC Score”) representing and measuring an Asset's financial rating, relative to its Optimal Technical Condition, with respect to multiple maintenance variables including the Asset's Scheduled Maintenance Program.

### BRIEF DESCRIPTION OF THE SEVERAL VIEWS OF THE DRAWINGS

The Process Diagrams detailed constitute a part of this specification and include exemplary embodiments to the invention, which may be embodied in various forms. It is to be understood that, in some instances, various aspects of the invention may be shown exaggerated or enlarged to facilitate an understanding of the invention.

FIG. 1: is a process diagram illustrating the Asset Grading System Process. The AGS Process starts with the determination of the Asset's Inspection Status (the Asset's status relative to the Inspection Interval listed in the Asset's Scheduled Maintenance Program) in order to calculate the Percentage Toward Event or PTE (represents the portion of the inspection interval consumed, in percentage terms) for each of the Asset's Inspections. Calculating the PIE allows for the calculation of the Asset Technical Condition Score, Asset Technical Financial Exposure Value, and/or the Asset Technical Financial Condition Score—the three elements comprising the Asset Technical Index. Once the ATC Score has been calculated, the ATC Score may be adjusted by a Non-Recoverable Deterioration Factor, defined as a factor that represents the natural deterioration of an Asset due to age. Although not required, the Non-Recoverable Deterioration Factor provides a more realistic representation of an Asset's technical condition when applied to the ATC Score.

FIG. 2: diagrams the process required to determine the Percentage Towards Event (represents the portion of the Inspection Interval consumed, in percentage terms) of each Inspection, Appliance (an instrument, mechanism, equipment, part, apparatus, appurtenance, or accessory, that is used or intended to be used in operating the Asset, and is installed in or attached to the Asset) and/or Asset. Calculation of the PTE starts with with the determination of the Assets Inspection Status. To determine the Assets Inspection Status, the Assets Maintenance History (a historical log of maintenance performed on an Asset as it relates to its Scheduled Maintenance Program) must be reconciled with the Asset's Scheduled Maintenance Program. This allows for the calculation of the Percentage Toward Event for each Inspection, Appliance, and the Asset.

FIG. 3: diagrams how the Asset Technical Condition Score for the Appliance and the Asset is derived following calculation of the PTE.

FIG. 4: diagrams the process for calculating the Adjusted Asset Technical Condition Score, following calculation of the ATC Score. To calculate the Adjusted Technical Condition Score, the ATC Score may be adjusted by a Non-Recoverable Deterioration Factor, a factor that represents the natural deterioration of an Asset due to age. The Non-Recoverable Deterioration Factor is dependent on each Asset's Non-Recoverable Variables (the class/type of Asset and the Appliance Grouping that determine the Non-Recoverable Deterioration Factor) and the Assets In-Service Period (the interval an Asset has been in use since being placed into service). Similar to the ATC Score, the Adjusted ATC Score (the ATC Score adjusted by the Non-Recoverable Deterioration Factor to account for the Asset's age) may be calculated at various levels including, but not limited to, the whole Asset, its components, subcomponents and/or Appliance Inspection Groups (a group of Inspections related to a specific Appliance).

FIG. 5: diagrams the process for calculating the Asset Technical Financial Exposure Value. The ATFE Value calculation is dependent on Asset Inspection Costs. (the cost associated with the various periodic actions detailed in the Asset's Scheduled Maintenance Program) obtained through external sources, and the Percentage Toward Event. The ATFE Value measures and represents the accrued Inspection liability due to utilization or other technical aging influence at various levels including, but not limited to, the whole Asset or Assets, its components, subcomponents and/or Appliance Inspection Groups.

FIG. 6: diagrams how the Percentage Toward Event and the Asset Technical Financial Exposure Value may be used to calculate the Asset Technical Financial Condition Score. The ATFC Score evaluates and represents an Asset's financial rating, relative to its Optimal Technical Condition, at various levels including, but not limited to, the whole Asset or Assets, its components, subcomponents and/or Appliance Inspection Groups.

FIG. 7: diagrams the Asset Grading System Process and identifies the three elements of the Asset Technical Index: the Asset Technical Condition Score, the Asset Technical Financial Exposure Value, and the Asset Technical Financial Condition Score.

For the convenience in understanding the preferred embodiment, aforementioned figures are referenced throughout the preferred embodiment. The figures should be understood to constitute a part of this specification only in part and also may include exemplary embodiments to the invention, which could also be embodied in various forms not directly provided. It is to be understood that, in some instances, various aspects of the invention may be shown exaggerated or enlarged to facilitate an understanding of the invention.

### DETAILED DESCRIPTION OF THE INVENTION

The invention can be implemented in numerous ways, including as a process; a system; a computer program product embodied on a computer readable storage medium; and/or a processor, such as a processor configured to execute instructions stored on and/or provided by a memory coupled to the processor. In this specification, these implementations, or any other form that the invention may take, the steps of disclosed processes may be altered within the scope of the invention. Unless stated otherwise, a component such as a specific process described as being configured to calculate a certain result may be implemented as a general component that is temporarily configured to perform the task at a given time or a specific component that is manufactured to perform the task.

A detailed description of one or more embodiments of the invention is provided below along with accompanying examples of the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

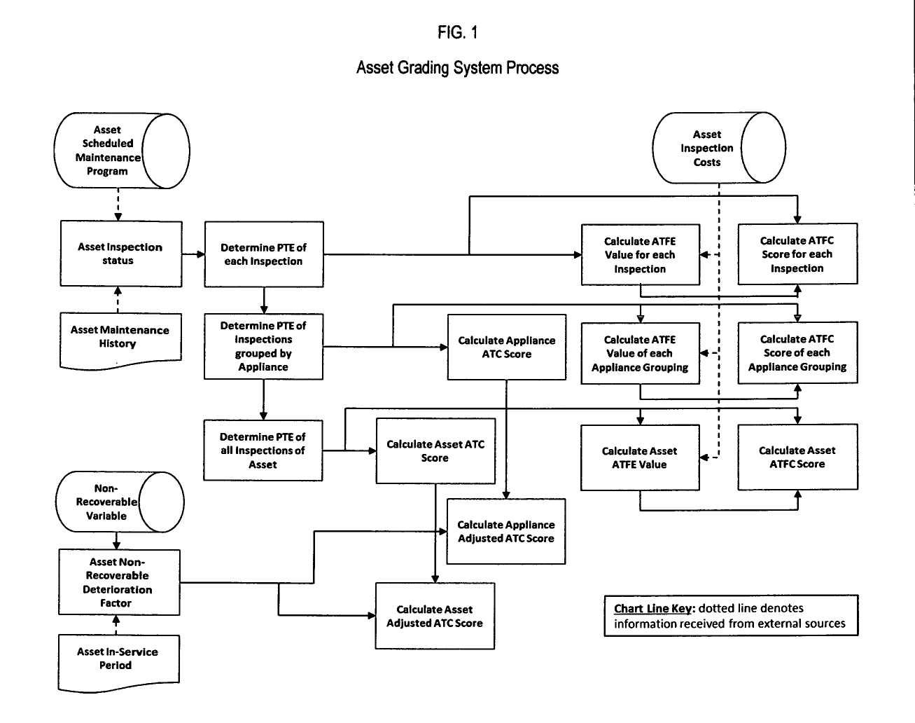

An Asset Grading System Process is disclosed, as illustrated on FIG. 1 that derives: an Asset Technical Index comprised of an Asset Technical Condition Score that evaluates and measures an Asset's technical condition, relative to its Optimal Technical Condition, with respect to multiple maintenance variables including the Asset's Scheduled Maintenance Program; an Asset Technical Financial Exposure Value, representing and measuring the Asset's accrued Inspection liability due to utilization or other technical aging influence, based on its Optimal Inspection Liability, with respect to multiple maintenance variables including the Asset's Scheduled Maintenance Program; and, an Asset Technical Financial Condition Score, representing and measuring an Asset's financial rating, relative to its Optimal Technical Condition, with respect to multiple maintenance variables including the Asset's Scheduled Maintenance Program.

In some embodiments, an Asset Technical Index is determined for one or more factors including, but not limited to: providing a uniform process for grading the technical condition of an Asset, including its related components, subcomponents, or any other logically derived technical makeup, and the Asset's related Financial Exposure; providing a systematic, standardized approach for grading the technical condition and Financial Exposure of a single asset or a portfolio of similar, dissimilar, and/or unique type assets; processing technical data and generating a grading Index for use in rating an Asset's technical condition and its Financial Exposure; providing the ability to generate a grade for the entire Asset and, to the extent appropriate for that class/type of Asset, the Asset Technical Index for the Asset's related components and subcomponents, and/or any other logically derived technical makeup. The Asset Technical Index may also be used to define the role that the Asset's technical condition plays, as part of a larger set of variables, to produce a set of data that can be translated into financial terms able to be acted upon to protect and/or enhance an Asset's financial performance. Additionally, the Asset Technical Index provides a systematically applied process to identify technical condition value enhancement or degradation trends with respect to a single and/or portfolio/group of Assets, and also provides a simple to understand approach for evaluating an Asset in relation to its Optimal Technical Condition in such a way that the overall financial performance of the Asset can be derived and measurably improved.

Using the Asset Grading System Process, individuals may reliably assess the technical condition of Assets. For example, the Asset Technical Index will allow anyone with an interest in the Asset to: objectively analyze & grade their Asset's technical condition; directly compare their Asset to similar, dissimilar, and/or unique class/type Assets; prove their Asset's maintenance condition grade; improve their Asset's maintenance condition grade; and/or, justify their sale/purchase price for an Asset through their Asset's direct comparison to one or more similar and/or dissimilar Assets.

The Asset Grading System Process for grading the technical condition of the Asset by deriving the Asset Insight Index starts by determining the Asset's Inspection Status—the Asset's status relative to the Inspections listed in the Asset's Scheduled Maintenance Program. To determine the Asset's Inspection Status, the Asset's Maintenance History must be reconciled with the Asset's Scheduled Maintenance Program, in order to calculate the Percentage Toward Event for each of the Asset's Inspections.

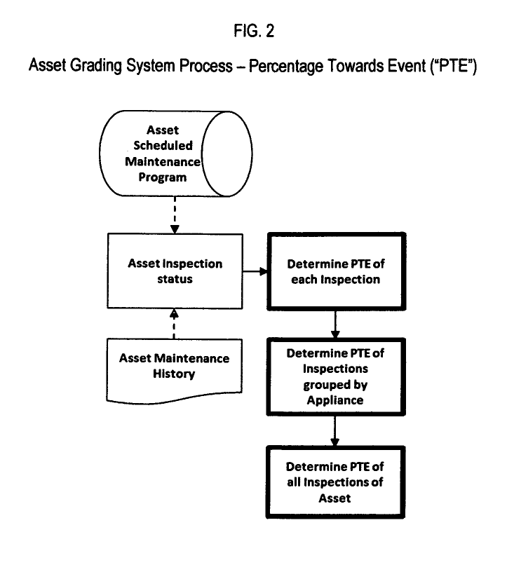

The Percentage Toward Event (“PTE”), shown on FIG. 2 represents the portion of the Inspection Interval (a period when a specific Inspection must be repeated, as specified by the Scheduled Maintenance Program) consumed, in percentage terms. To calculate the PTE, the Asset's Inspection Status must first be determined. Once this is accomplished, the PTE of each Inspection can be determined based on the Asset Scheduled Maintenance Program Inspection Interval.

The Scheduled Maintenance Program Inspection Interval may be based on Value Intervals (a Scheduled Maintenance Program Inspection Interval that is based on a single value or a plurality of values). In such a case, if the current Value Interval, less the most recent Value Interval, divided by the Inspection Interval, is less than the Max Usage (the Inspection Interval period published in the Asset's Scheduled Maintenance Program), then the current Value Interval PTE is equal to the current Value Interval, less the most recent Value Interval, divided by the Inspection Interval. If the current Value Interval less the most recent Value Interval divided by the Inspection Interval is equal to or greater than the Max Usage, then the current Value Interval PTE is equal to the Max Usage.

The Scheduled Maintenance Program may also be based on Time Intervals (a Scheduled Maintenance Program Inspection Interval that is based on a period of time). In such a case, if the current Time Interval, less the most recent Time Interval, divided by the Inspection Interval, is less than the Max Usage, then the current Time Interval PTE is equal to the current Time Interval, less the most recent Time Interval, divided by the Inspection Interval. If the current Time Interval, less the most recent Time Interval, divided by the Inspection Interval, is equal to or greater than the Max Usage, then the current Time Interval PTE is equal to the Max Usage.

Calculating the PTE allows for the calculation of, but is not limited to, the following: Asset Technical Condition Score; Asset Technical Financial Exposure Value; and/or the Asset Technical Financial Condition Score—the three elements comprising the Asset Technical Index.

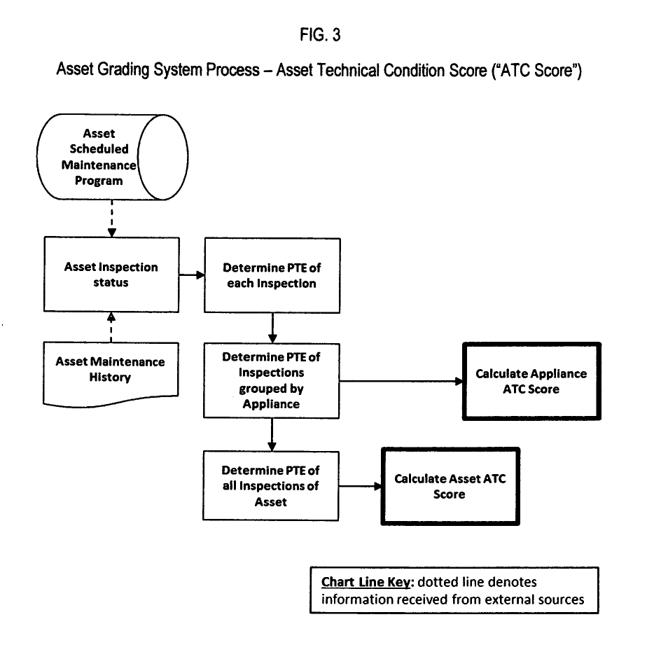

The Asset Technical Condition Score (“ATC Score”) shown on FIG. 3 evaluates and measures an Asset's technical condition, relative to its Optimal Technical Condition, with respect to multiple maintenance variables including the Asset's Scheduled Maintenance Program.

The ATC Score may be calculated at various levels including, but not limited to, the whole Asset, its components, subcomponents and/or Appliance Inspection Groups. Utilizing the PTE calculation, we are able to calculate the ATC Score for each of the various levels.

For example, to calculate the ATC Score for an Appliance Inspection Group, the count of all Inspection Items (a periodic action detailed in the Asset's Scheduled Maintenance Program) in the Appliance Inspection Group, less the sum of the PTEs of all Inspection Items in the Appliance Inspection Group, is divided by the count of all Inspection Items in the Appliance Inspection Group, and standardized to a set scale for that class/type Asset, which can include such alternatives, modifications, and equivalents as may be within the spirit and scope of the invention.

Similarly, by way of an additional example, to calculate the ATC Score for an Asset, the count of all Inspection Items in the Asset, less the sum of the PTEs of all Inspection Items in the Asset, is divided by the count of all Inspection Items in the Asset, standardized to a set scale for that class/type Asset, which can include such alternatives, modifications, and equivalents as may be within the spirit and scope of the invention.

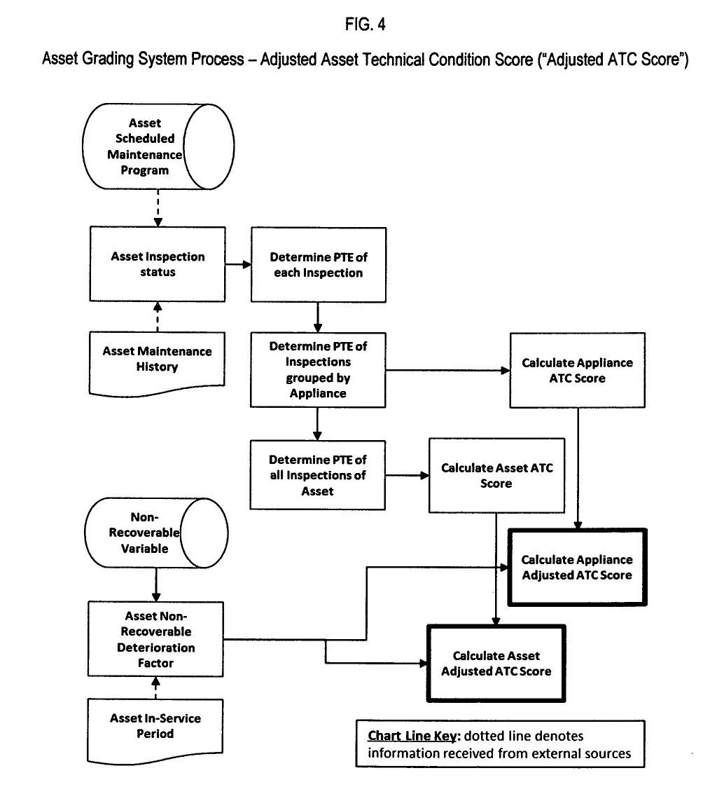

Once the ATC Score has been calculated, the ATC Score may be adjusted by a Non-Recoverable Deterioration Factor, a factor that represents the natural deterioration of an Asset due to age. Although not required, the Non-Recoverable Deterioration Factor detailed on FIG. 4 provides a more realistic representation of an Asset's technical condition when applied to the ATC Score.

The Non-Recoverable Deterioration Factor is dependent on each Asset's Non-Recoverable Variables and the Asset's In-Service Period, the interval an Asset has been in use since being placed into service. The Asset's Non-Recoverable Deterioration Factor is the time interval since the Asset's date of manufacture divided by a given time period, dependent upon the desired precision, such as daily, weekly, monthly, annually, or any other standardized time interval. Obtaining the Non-Recoverable Deterioration Factor allows for the calculation of the Adjusted Asset Technical Condition Score (“Adjusted ATC Score”).

The Adjusted Asset Technical Condition Score detailed on FIG. 4 provides a more realistic representation of an Asset's technical condition through the use of the Non-Recoverable Deterioration Factor, or any other factor, to account for the Asset's age.

Similar to the ATC Score, the Adjusted ATC Score may be calculated at various levels including, but not limited to, the whole Asset, its components, subcomponents and/or Appliance Inspection Groups.

For example, the Adjusted ATC Score for an Appliance Inspection Group would be the difference between the ATC Score and the Non-Recoverable Deterioration Factor for that class/type of Appliance Inspection Group.

Similarly, by way of an additional example, the Adjusted ATC Score for an Asset would be the difference between the ATC Score and the Non-Recoverable Deterioration Factor for that class/type of Asset.

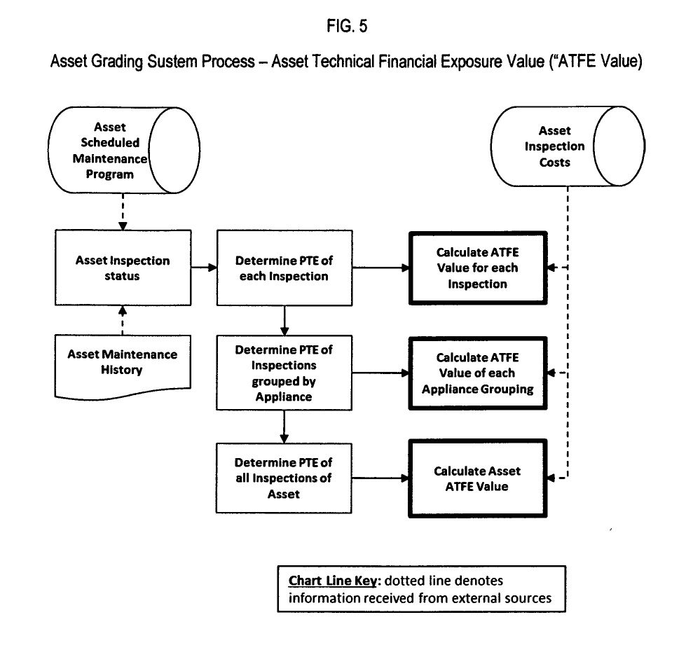

The Asset Technical Financial Exposure Value (“ATFE Value”) referenced on FIG. 5 is dependent on Asset Inspection Costs obtained through external sources. The Inspection Costs associated with the various periodic actions detailed in the Scheduled Maintenance Program can include, but are not limited to, the cost of replacement parts and labor.

The Percentage Toward Event (“PTE”) defined previously may be used to calculate the Asset Technical Financial Exposure Value. The ATFE Value measures and represents the accrued Inspection liability due to utilization or other technical aging influence, relative to its Optimal Inspection Liability, at various levels including, but not limited to, the whole Asset or Assets, its components, subcomponents and/or Appliance Inspection Groups.

For example, the Inspection ATFE Value is equal to the Inspection Cost associated with each Inspection multiplied by the Inspection PTE.

Similarly, an aggregate of these ATFE Values may be used. For example, the Appliance ATFE Value is equal to the sum of all Inspection ATFE Values for the Appliance Group (a group of Inspections related to a specific Appliance). The Asset ATFE Value is equal to the sum of all Inspection ATFE Values for the Asset.

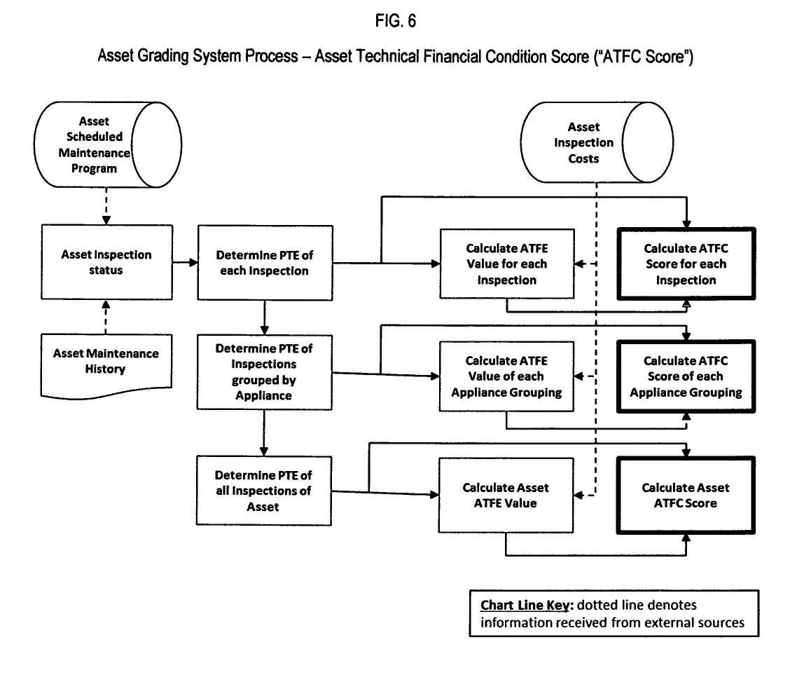

The Percentage Toward Event defined previously, in addition to the ATFE Value, also previously defined, may be used to calculate the Asset Technical Financial Condition Score (“ATFC Score”) referenced on FIG. 6. The ATFC Score evaluates and represents an Asset's financial rating, relative to its Optimal Technical Condition, at various levels including, but not limited to, the whole Asset or Assets, its components, subcomponents and/or Appliance Inspection Groups.

For example, the Inspection ATFC Score is equal to the difference between the Inspection Cost and the Inspection ATFE Value, divided by the sum of all Inspection Costs, standardized to a set scale for that class/type Asset, which can include such alternatives, modifications, and equivalents as may be within the spirit and scope of the invention.

Similarly, an aggregate of these ATFC Scores may be used. For example, the Appliance ATFC Score is equal to the difference between the sum of all Inspection Costs for an Appliance Group and the sum of all ATFE Values for an Appliance Group, divided by the sum of all Inspection Costs, standardized to a set scale for that class/type Asset, which can include such alternatives, modifications, and equivalents as may be within the spirit and scope of the invention. The Asset ATFC Score is equal to the difference between the sum of all Inspection Costs for an Asset and the sum of all ATFE Values for an Asset, divided by the sum of all Inspection Costs, standardized to a set scale for that class/type Asset, which can include such alternatives, modifications, and equivalents as may be within the spirit and scope of the invention.

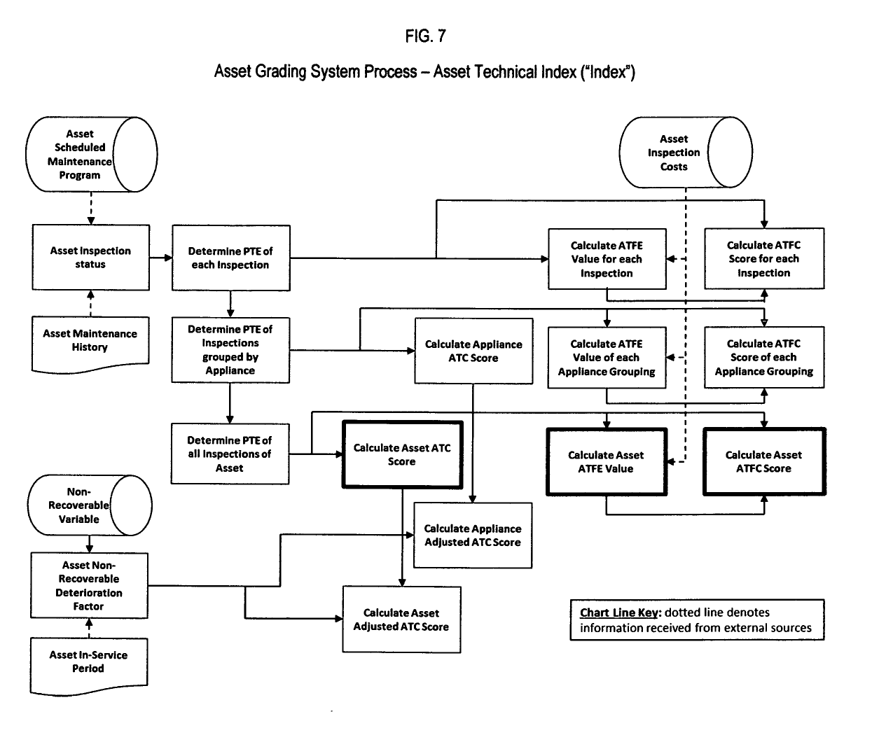

The Asset Technical Index (“Index”) referenced on FIG. 7, represents an Asset's grade, as derived by the embodied Asset Grading System Process, comprised of the Asset Technical Condition Score, the Asset Technical Financial Exposure Value, and the Asset Technical Financial Condition Score.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for grading, based on a set scale, the aggregated pluralities of conditions of an Asset based on a plurality of factors; more specifically, using recommended actions originating from a plurality of sources.

2. The process of claim 1, wherein the set scale is standardized across class/type of Assets.

3. The process of claim 1, wherein the aggregated pluralities of conditions are conditions that when aggregated comprise the overall technical condition of an Asset.

4. The process of claim 1, where in the plurality of factors and, subsequently, the recommended actions, includes any or all Scheduled Maintenance Programs made available by an Asset's manufacturer or any other governing authority.

5. The process of claim 1, wherein a plurality of sources includes any or all Scheduled Maintenance Programs made available by an Asset's manufacturer or any other governing authority.

6. The process of claim 5, wherein a Schedule Maintenance Program may include any periodic actions recommended and/or required by the Asset's manufacturer, and/or any other governing authority (such as a Federal, State or Local governing entity), detailing the plurality of Inspections necessary for the Asset to operate at an acceptable technical level.

7. A system that grades Assets based on a set scale that derives an Index which may be used to evaluate and measure an Asset's aggregated pluralities of conditions, relative to its plurality of states, with respect to the Asset's plurality of maintenance variables, accrued aging, based on its plurality of states with respect to the plurality of maintenance variables, and/or the Asset's financial state, relative to its plurality of states, with respect to the plurality of maintenance variables.

8. The system of claim 7, wherein aging variable includes liability resulting from utilization or any other technical aging influence.

9. The system of claim 7, wherein the Index may include a process measuring the relationship between technical condition and a plurality of states, with reference to a plurality of maintenance variables [see FIG. 3].

10. The system of claim 7, wherein the Index may include a process, measuring the level of exposure of an Asset, based on the plurality of accrued liability, with reference to a plurality of maintenance variables [see FIG. 4].

11. The system of claim 10, wherein the level of exposure is a financial value correlating to the amount of usage of an Asset's financial value.

12. The system of claim 7, wherein the Index may include a process measuring an Asset's financial state with relation to a plurality of states and their relation to a plurality of maintenance variables [see FIG. 6].

13. The system of claim 7, 9, and 12, wherein a plurality of states contains, but is not limited to, Optimal Technical Condition.

14. The system of claim 13, wherein Optimal Technical Condition is a condition that cannot be improved upon.

15. The system of claim 7, 9, 10, and 12, wherein a plurality of maintenance variables includes periodic actions recommended and/or required by the Asset's manufacturer, and/or any other governing authority (such as a Federal, State or Local governing entity), detailing the plurality of Inspections necessary for the Asset to operate at an acceptable technical level.

16. The system of claim 6 and 15, wherein periodic actions may be any action or group of actions recommended at a definable interval.

17. The system of claim 6 and 15, wherein plurality of Inspections may include checks, repairs, or any other maintenance related action.

18. The system of claim 6 and 15, wherein an acceptable technical level contains those levels which deem an Asset in proper and/or safe working order.
